(19) United States
(12) Patent Application Publication
(10) Pub. No.: US 2011/0059368 A1
(43) Pub. Date: Mar. 10, 2011

(54) SEPARTOR FOR HIGH-POWER DENSITY LITHIUM ION SECONDARY BATTERY (AS AMENDED)

(76) Inventors: Daisuke Inagaki, Tokyo (JP); Yoshihiko Izumi, Tokyo (JP)

(21) Appl. No.: 12/991,664

(22) PCT Filed: May 11, 2009
(86) PCT No.: PCT/JP2009/058748

§ 371 Date: Nov. 8, 2010

(30) Foreign Application Priority Data
May 9, 2008 (JP) 2008-123727

(51) Int. Cl. H01M 2/14; H01M 2/16

(52) U.S. Cl. 429/246; 429/254

(57) ABSTRACT

There is provided a separator for a high-power density lithium ion secondary battery, the separator comprising a polyolefin microporous membrane, wherein the polyolefin microporous membrane has a tensile strength in the longitudinal direction (MD) of 50 MPa or higher and a tensile strength in the transverse direction (TD) of 50 MPa or higher, and a sum total of an MD tensile elongation and a TD tensile elongation of 20 to 250%; and the polyolefin microporous membrane comprises a polypropylene.

### TECHNICAL FIELD

The present invention relates to a separator for a high-power density lithium ion secondary battery.

### BACKGROUND ART

Polyolefin microporous membranes are broadly used as separation or permselective separation membranes, separator materials and the like for various types of substances, and examples of applications thereof include microfiltration membranes, separators for fuel cells and capacitors, base materials of functional membranes to develop new functions by filing pores thereof with functional materials, and separators for batteries. Particularly, polyolefin microporous membranes are suitably used as separators for lithium ion batteries broadly used for laptop personal computers, cellular phones, digital cameras and the like.

Lithium ion secondary batteries used in applications to electric tools, motorbikes, bicycles, cleaners, carts, automobiles and the like have been required to have a higher-power density, and electrodes, polyolefin microporous membranes as separators, and electrolyte solutions have conventionally been improved, respectively. The power density is determined by the expression below from a discharge end voltage (3.0 V) of a battery, a current value (I) obtained by extrapolating a straight line of a current-voltage characteristic thereof to the discharge end voltage in a diagrammatic drawing showing a relation between the battery voltage at 50% of SOC (state of charge) and the discharge current, and a battery mass (Wt).

Power density (P)=(V×I)/Wt

Here, “a high-power density” means a power density of 1,000 W/kg or more, and is more preferably 1,100 W/kg or more, and especially preferably 1,200 W/kg or more. Generally, the lithium ion secondary battery which has a high-power density simultaneously indicates having a high-input density in the point that the battery makes a high-speed lithium ion transfer possible. “A high-power density” used in the present application also means an input density of 800 W/kg or more, and is more preferably 850 W/kg or more, and especially preferably 900 W/kg or more.

Patent Document 1 proposes a microporous membrane composed of a mixture of a high-molecular weight polyethylene and a high-molecular weight polypropylene. Patent Document 2 proposes that a lithium ion conductive substance is dispersed in a separator to achieve a low resistance to thereby apply the separator to a lithium ion secondary battery for high-power density uses.
Patent Document 1: Japanese Patent No. 3342755
Patent Document 2: Japanese Patent Laid-Open No. 2007-141591

### DISCLOSURE OF THE INVENTION

### Problems to be Solved by the Invention

As a separator for a high-power density lithium ion secondary battery, a separator having pores of a large pore diameter and a high porosity is generally used from the viewpoint of achieving a high ion permeability. However, in conventional separators, batteries easily self-discharge due to the “large pore diameter” and the “high porosity”, and there is still room to be improved from the viewpoint of the high-rate characteristic. Here, the “high-rate characteristic” indicates a ratio of a battery capacity when a battery is discharged at a high current to a definite voltage to a battery capacity when the battery is discharged at a low current to the definite voltage, and a higher ratio can be said to be good.

A size of the high-power density lithium ion secondary battery is likely to become large from the viewpoint of achieving a higher-power density. In this case, a winding number of the separator in the battery is likely to become large, and a pass line length of the separator is likely to become long. A polyolefin microporous membrane more superior in quality is required in the point of the uniformity (generation of no warping) of the separator from the viewpoint of making a stable battery production possible even with a long pass line.

However, the microporous membranes described in Patent Documents 1 and 2 still have room to be improved in consideration of the application to lithium ion secondary batteries for uses in a high-power density.

It is an object of the present invention to provide a separator for a high-power density lithium ion secondary battery, which can achieve a lithium ion secondary battery suppressed in the self-discharge, and excellent in the high-rate characteristic, and has an excellent uniformity.

### Means for Solving the Problems

As a result of exhaustive studies to achieve the above-mentioned object, the present inventors have found that a polyolefin microporous membrane having a specific composition and specific physical properties of the membrane can solve the above-mentioned problems. These findings have led to the completion of the present invention.

That is, the present invention is as follows.
[1] A separator for a high-power density lithium ion secondary battery, the separator comprising a polyolefin microporous membrane,

wherein the polyolefin microporous membrane has a tensile strength in a longitudinal direction (MD) of 50 MPa or higher and a tensile strength in a transverse direction (TD) of 50 MPa or higher, and a sum total of an MD tensile elongation and a TD tensile elongation is 20 to 250%; and

the polyolefin microporous membrane comprises a polypropylene.
[2] The separator for the high-power density lithium ion secondary battery according to the above [1], wherein the polyolefin microporous membrane has an average pore diameter of less than 0.1 μm.
[3] The separator for the high-power density lithium ion secondary battery according to the above [1] or [2], wherein the polyolefin microporous membrane has a TD thermal shrinkage at 65° C. of 1.0% or lower.
[4] The separator for the high-power density lithium ion secondary battery according to any one of the above [1] to [3], wherein the polyolefin microporous membrane has a porosity of 40% or higher.
[5] The separator for the high-power density lithium ion secondary battery according to any one of the above [1] to [4], wherein the polyolefin microporous membrane has a membrane thickness of 20 μm or more.
[6] A high-power density lithium ion secondary battery, comprising the separator for the high-power density lithium ion secondary battery according to any one of the above [1] to [5], a positive electrode, a negative electrode and an electrolyte solution.

### Advantages of the Invention

The present invention can provide a separator for a high-power density lithium ion secondary battery, which can achieve a lithium ion secondary battery suppressed in the self-discharge, and excellent in the high-rate characteristic, and has an excellent uniformity.

### MODE FOR CARRYING OUT THE INVENTION

Hereinafter, a mode for carrying out the present invention (hereinafter, abbreviated to “the present embodiment”) will be described in detail. Here, the present invention is not limited to the following embodiment, and can be practiced within the gist thereof by making various changes and modifications.

The separator for the high-power density lithium ion secondary battery (hereinafter, simply abbreviated to “separator” in some cases) according to the present embodiment comprises a polyolefin microporous membrane (hereinafter, simply abbreviated to “microporous membrane” in some cases). The microporous membrane has continuous micro pores in the membrane thickness direction, and has, for example, a three-dimensional network skeleton structure. The microporous membrane has a tensile strength in the longitudinal direction (having the same meaning as the raw material resin discharge direction or the machine direction, and abbreviated to “MD” in some cases) of 50 MPa or higher and a tensile strength in the transverse direction (which is a direction orthogonal to the longitudinal direction, and is abbreviated to “TD” in some cases) of 50 MPa or higher, and exhibits a sum total of an MD tensile elongation and a TD tensile elongation of 20 to 250%, and comprises a polypropylene.

The separator according to the present embodiment employing such a constitution can achieve especially a good high-rate characteristic and a low self-discharge characteristic required for a high-power density lithium ion secondary battery, and achieve an excellent uniformity. The separator according to the present embodiment is suitable as a separator for a high-power density lithium ion secondary battery.

The porosity of the microporous membrane is preferably 30% or higher, more preferably 35% or higher, and still more preferably 40% or higher, from the viewpoint of complying with a rapid migration of lithium ions at the high-rate. From the viewpoint of the membrane strength and the self-discharge, the porosity thereof is preferably 90% or lower, more preferably 80% or lower, and still more preferably 60% or lower.

On the other hand, an average pore diameter of the microporous membrane is preferably less than 0.1 μm (in the case of the maximum pore diameter by the bubble point method, the diameter is preferably 0.09 μm or less from the viewpoint of preventing the self-discharge), more preferably 0.09 μm or less, and still more preferably 0.08 μm or less, from the viewpoint of preventing the self-discharge. The average pore diameter less than 0.1 μm is preferable, particularly in a battery having a high-power density, from the viewpoint that the self-discharge hardly occurs during storage after charging. The lower limit thereof is not especially limited, but is preferably 0.01 μm or more, more preferably 0.02 μm or more, and still more preferably 0.03 μm or more, from the viewpoint of a balance between an air permeability and the self-discharge.

The air permeability of the microporous membrane is preferably 1 sec or more, more preferably 50 sec or more, and still more preferably 100 sec or more, from the viewpoint of a balance among the membrane thickness, the porosity and the average pore diameter. From the viewpoint of the permeability, the air permeability thereof is preferably 400 sec or less, and more preferably 300 sec or less.

The tensile strength of the microporous membrane is 50 MPa or higher, and more preferably 70 MPa or higher, in both the MD and TD directions. Making the tensile strength in the MD and TD directions to be 50 MPa or higher is preferable from the viewpoint that breakage thereby hardly occurs during slitting and battery winding, or that short circuit due to foreign matters and the like in a battery thereby hardly occurs. The tensile strength is preferable also from the viewpoint that a membrane thereby easily maintains its original pore structure against expansion/contraction of an electrode during the high-rate test or the like to thereby allow to alleviate decreases in the characteristics. On the other hand, the upper limit value is not especially limited, but is preferably 500 MPa or lower, more preferably 300 MPa or lower, and still more preferably 200 MPa or lower, from the viewpoint of the simultaneous satisfaction with a low shrinkage.

The MD tensile elongation and the TD tensile elongation of the microporous membrane are preferably each 10 to 150%, and the sum total thereof is preferably 20 to 250%, more preferably 30 to 200%, and especially preferably 50 to 200%. If the sum total of the MD and TD tensile elongations is 20 to 250%, since proper orientation can easily develop a sufficient strength, and a uniform stretching can easily be carried out in the stretching process to thereby give an excellent membrane thickness distribution, as a result, the battery windability is likely to be improved. Further since the pore structure hardly changes against the expansion/contraction of the electrode during the high-rate test or the like, the characteristics become to be easily maintained.

Setting the tensile strength and the tensile elongation in the ranges described above alleviates a stretching unevenness during stretching to thereby improve the membrane thickness distribution, and, also with respect to a reel after slitting, can achieve the reel excellent in uniformity, for example, warping of 1 mm or less. A microporous membrane whose tensile strength and tensile elongation have been set in the ranges described above further develops an astonishing effect of easily maintaining its original pore structure even in use at a large current near 10 C (a current 10 times one-hour charge rate (1 C) of a rated electric capacity), and as a result, providing the excellent high-rate characteristic and self-discharge characteristic.

A puncture strength (absolute strength) of the microporous membrane is preferably 3 N or higher, and more preferably 5 N or higher. Making the puncture strength to be 3 N or higher is preferable from the viewpoint of being capable of reducing occurrence of pinholes and cracks when the microporous membrane is punctured with sharp portions of electrodes and the like in the case of using the microporous membrane as a battery separator. The upper limit thereof is preferably 10 N or lower, and more preferably 8 N or lower, from the viewpoint of the simultaneous satisfaction with a low thermal shrinkage.

A membrane thickness of the microporous membrane is not especially limited, but is preferably 1 μm or more from the viewpoint of the membrane strength, and preferably 500 μm or less from the viewpoint of the permeability. The membrane thickness is preferably 20 μm or more, more preferably 22 μm or more, and especially preferably 23 μm or more, from the viewpoint of being used for a battery having a high-power density exhibiting a relatively high calorific value and requiring a better self-discharge characteristic than conventionally, including safety tests, and from the viewpoint of the windability by a large battery winding machine. The upper limit thereof is preferably 100 μm or less, and more preferably 50 μm or less.

Examples of means to form the microporous membrane provided with various characteristics as described above include, for example, a method in which the polymer concentration and the stretch ratio in extrusion, and stretching and relaxation operation after extraction are optimized, and, particularly with respect to the regulation of the elongation, include a method in which a polypropylene is blended with a polyethylene.

The form of the microporous membrane may be a form of a single layer or a form of a laminate. The laminate refers to lamination of a microporous membrane in the present embodiment with a nonwoven fabric or another microporous membrane, or surface coating thereof with an inorganic component or an organic component. As long as the physical properties of the laminate are in the ranges of the present embodiment, the form is not especially limited.

Then, a method for manufacturing the polyolefin microporous membrane will be described, but as long as a microporous membrane obtained satisfies requirements of the present embodiment, there are no limitations in types of polymer, types of solvent, extrusion methods, stretching methods, extraction methods, pore-forming methods, heat setting and heat treatment methods, and the like.

The method for manufacturing the microporous membrane preferably comprises a step of melting, kneading and extruding a polymer material, a plasticizer, or a polymer material, a plasticizer and an inorganic material, a stretching step, a plasticizer (including an inorganic material as required) extraction step, and further a step of thermally setting.

More specifically, for example, a method comprising each step of (a) to (d) described below is included.
(a) A kneading step of kneading a polyolefin, a plasticizer, and an inorganic material as required.
(b) A sheet forming step of extruding the kneaded material after the kneading step, forming the extruded material into a sheet shape (which may be a single layer or a laminate), and cooling and solidifying the formed material.
(c) A stretching step of extracting the plasticizer and the inorganic material as required after the sheet forming step, and further stretching the sheet to the uni- or multi-axial directions.
(d) A post-processing step of extracting the plasticizer and the inorganic material as required after the stretching step, and further subjecting the stretched sheet to a heat treatment.

Examples of polyolefins used in the (a) step described above include homopolymers of ethylene and propylene, and copolymers formed of at least two or more monomers selected from the group consisting of ethylene, propylene, 1-butene, 4-methyl-1-pentene, 1-hexene, 1-octene and norbornene. These may be used as a mixture. Use of a mixture thereof facilitates control of the fuse temperature and the short temperature, which is preferable. Particularly, blending of two or more types of polyethylene is preferable, and making an ultrahigh molecular weight polyolefin having a viscosity-average molecular weight (hereinafter, abbreviated to “Mv” in some cases) of 500,000 or higher and a polyolefin having Mv of less than 500,000 contained in the microporous membrane is especially preferable from the viewpoint of being capable of alleviating warping of the separator and reducing the thermal shrinkage. For this reason, it is presumed that contribution of the ultrahigh-molecular weight polyolefin component to a high elastic modulus of the membrane and the uniformity of the membrane thickness alleviates warping of the separator. Further, it is conceivable that the ultrahigh-molecular weight polyolefin component exhibits a high characteristic of maintaining the pore structure, and allows for the heat setting at a higher temperature, and can reduce the thermal shrinkage.

A polyethylene to be blended is preferably a high-density homopolymer from the viewpoint that pores are not clogged and the heat setting can be carried out at a higher temperature. A whole microporous membrane preferably has My of 100,000 or higher, and 1,200,000 or lower, and more preferably 300,000 or higher and 800,000 or lower. If the whole microporous membrane has Mv of 100,000 or higher, the membrane breaking resistance during melting will tend to be developed; and if the whole microporous membrane has My of 1,200,000 or lower, the extrusion step will tend to be facilitated, and the relaxation of the shrinking force during melting will tend to be faster and the thermal resistance will tend to be improved.

Blending a polypropylene in a polyolefin has an effect on the decrease in the tensile elongation because an interface is easily formed between the polypropylene and the polyethylene matrix. This makes it easy for the tensile elongation to be regulated to a desired one, and consequently, the membrane thickness distribution is made good because a uniform force can easily be applied over the whole membrane during stretching. Blending of a polypropylene allows for easily making a small pore diameter in the phase separation. Mv of a polypropylene to be blended is preferably 100,000 or more from the viewpoint of the membrane breaking resistance during melting, and preferably less than 1,000,000 from the viewpoint of the formability.

A blending amount of the ultrahigh-molecular weight polyolefin having a viscosity-average molecular weight of 500,000 or higher to the whole polyolefin used in the (a) step described above is preferably 1 to 90% by mass, more preferably 5 to 80% by mass, and still more preferably 10 to 70% by mass. If the blending amount of the ultrahigh-molecular weight polyolefin having a viscosity-average molecular weight of 500,000 or higher is in the range described above, the ultrahigh-molecular weight component easily contributes to the high elastic modulus of the membrane and the uniformity of the membrane thickness, and is likely to easily maintain the pore structure.

The blending amount of the polyolefin having a viscosity-average molecular weight of lower than 500,000 to the whole polyolefin used in the (a) step described above is preferably 1 to 90% by mass, more preferably 5 to 80% by mass, and still more preferably 10 to 70% by mass. If the blending amount of the polyethylene having a viscosity-average molecular weight of lower than 500,000 is in the range described above, proper entanglement with the ultrahigh-molecular weight component is formed, whereby a membrane having a good thickness distribution is likely to be easily obtained.

The blending amount of a polypropylene to the whole polyolefin used in the (a) step described above is preferably 1 to 80% by mass, more preferably 2 to 50% by mass, still more preferably 3 to 20% by mass, and especially preferably 5 to 10% by mass. With the blending amount of the polypropylene of 1% by mass or more, the effect described above is likely to be developed; and with the blending amount thereof of 80% by mass or less, the permeability is likely to be easily secured.

To the polyolefin used in the (a) step described above, well-known additives may further be mixed, such as metal soaps such as calcium stearate and zinc stearate, ultraviolet absorbents, light stabilizers, antistatic agents, antifogging agents and coloring pigments.

The plasticizer includes an organic compound which can form a homogeneous solution with the polyolefin at a temperature equal to or lower than the boiling point. Specifically, examples thereof include decalin, xylene, dioctyl phthalate, dibutyl phthalate, stearyl alcohol, oleyl alcohol, decyl alcohol, nonyl alcohol, diphenyl ether, n-decane, n-dodecane and paraffin oil. Above all, paraffin oil and dioctyl phthalate are preferable.

The proportion of the plasticizer is not especially limited, but preferably 20% by mass or more with respect to the sum total mass of the polyolefin, the plasticizer, and an inorganic material blended as required from the viewpoint of the porosity of the microporous membrane obtained, and preferably 90% by mass or less with respect thereto from the viewpoint of the viscosity. From the viewpoint of imparting a characteristic of a small pore diameter although having a high porosity, the proportion is preferably 50 to 80% by mass, and more preferably 60 to 75% by mass.

Examples of the inorganic material include oxide-based ceramics such as alumina, silica (silicon oxide), titania, zirconia, magnesia, ceria, yttria, zinc oxide and iron oxide, nitride-based ceramics such as silicon nitride, titanium nitride and boron nitride, ceramics such as silicon carbide, calcium carbonate, aluminum sulfate, aluminum hydroxide, potassium titanate, talc, kaolin clay, kaolinite, halloysite, pyrophyllite, montmorillonite, sericite, mica, amesite, bentonite, asbestos, zeolite, calcium silicate, magnesium silicate, diatomaceous earth and quartz sand, and glass fibers. These may be used singly or concurrently in two or more. Above all, silica, alumina and titania are more preferable, and silica is especially preferable, from the viewpoint of the electrochemical stability.

A kneading method, for example, involves previously mixing a part or the whole of raw materials according to needs by a Henschel mixer, a ribbon blender, a tumbler blender or the like. Then, all the raw materials are melted and kneaded by a screw extruder such as a single-screw extruder or a twin-screw extruder, a kneader, a mixer or the like. The kneaded material is extruded through a T-die, an annular die or the like. At this time, the extrusion may be carried out as a single layer or a laminate.

On kneading, it is preferable that after an antioxidant is mixed in a predetermined concentration to a raw material polymer, the atmosphere of kneading is replaced by a nitrogen atmosphere, and the melting and kneading is carried out in the condition of maintaining the nitrogen atmosphere. A temperature at the melting and kneading is preferably 160° C. or higher, and more preferably 180° C. or higher. The temperature is preferably lower than 300° C., more preferably lower than 240° C., and still more preferably lower than 230° C.

Examples of methods for forming a sheet include a method in which a melted material melted, kneaded and extruded is solidified by compression cooling. The cooling methods include a method in which the melted material is brought into direct contact with a cooling medium such as cool air or cool water, and a method in which the melted material is brought into contact with a roll or a press machine cooled with a refrigerant, but the latter method is preferable from the viewpoint of excellent control of the membrane thickness.

Methods for stretching a sheet include the MD uniaxial stretching by a roll stretching machine, the TD uniaxial stretching by a tenter, the successive biaxial stretching by a combination of a roll stretching machine and a tenter, or a tenter and a tenter, and the simultaneous biaxial stretching by a simultaneous biaxial tenter or an inflation forming. The simultaneous biaxial stretching is preferable from the viewpoint of providing a more uniform membrane. The total area stretch ratio is preferably 8 or more times, more preferably 15 or more times, and still more preferably 30 or more times, from the viewpoint of a balance among the uniformity of the membrane thickness, the tensile strength, the porosity and the average pore diameter. With the area stretch ratio of 30 or more times, a sheet having a high strength and a low elongation is likely to be easily provided.

The extraction of the plasticizer and the inorganic material can be carried out by a method in which these are immersed in, or showered with an extraction solvent. As the extraction solvent, a solvent is preferable which is a poor solvent to the polyolefin, a good solvent to the plasticizer and the inorganic material, and has a lower boiling point than the melting point of the polyolefin. Examples of such an extraction solvent usable include hydrocarbons such as n-hexane and cyclohexane, halogenated hydrocarbon such as methylene chloride, 1,1,1-trichloroethane and fluorocarbons, alcohols such as ethanol and isopropanol, ketones such as acetone and 2-butanone, and alkaline water. These solvents may be used singly or as a mixture thereof.

The inorganic material may be extracted in the whole amount or a part thereof in any one of all the steps, or may be left remaining in a product. The order, the method and the number of times of the extraction are not especially limited. The extraction of the inorganic material may not be carried out according to needs.

Methods of heat treatment include a method of heat setting in which the stretching, the relaxation operation and the like are carried out utilizing a tenter or a roll stretching machine. The relaxation operation refers to a shrinking operation on the MD and/or the TD of a membrane in a certain relaxation rate. The relaxation rate refers to a value of an MD size of a membrane after the relaxation operation divided by an MD size of the membrane before the operation, a value of a TD size after the relaxation operation divided by a TD size of the membrane before the operation, or, in the case where both the MD and TD are relaxed, a value of a relaxation rate of the MD multiplied by a relaxation rate of the TD. The predetermined temperature is preferably 100° C. or higher from the viewpoint of the thermal shrinkage, and preferably lower than 135° C. from the viewpoint of the porosity and the permeability. The predetermined relaxation rate is preferably 0.9 or less, and more preferably 0.8 or less, from the viewpoint of the thermal shrinkage. The relaxation rate is preferably 0.6 or more from the viewpoint of the prevention of occurrence of wrinkles, and the porosity and the permeability. Although the relaxation operation may be carried out in both the MD and TD directions, even by the relaxation operation in the MD or TD alone, the thermal shrinkage not only in the operational directions but also in the direction perpendicular to the operation can be reduced.

The method for manufacturing the microporous membrane can employ, in addition to the each step of (a) to (d), a step of stacking a plurality of single layers as a step of obtaining a laminate. The method can further employ a surface treatment step including electron beam irradiation, plasma irradiation, surfactant coating and chemical modification.

A wound membrane roll after the heat setting (hereinafter, referred to as “master roll”) may further be subjected to a treatment at a predetermined temperature (aging operation of a master roll), and thereafter the master roll may be subjected to a wound-back operation. This step relieves residual stresses of the polyolefin in the master roll. The temperature for the heat treatment of the master roll is preferably 35° C. or higher, more preferably 45° C. or higher, and still more preferably 60° C. or higher. The temperature is preferably 120° C. or lower from the viewpoint of the retention of the permeability. The heat treatment time is not limited, but preferably 24 or more hours because of easily developing the effect.

Generally, although the above-mentioned heat setting is effective for reduction of the thermal shrinkage in the range of 100° C. or higher, such a method has a difficulty in effectively eliminating residual stresses at a relatively low temperature, for example, at 65° C. Therefore, carrying out the above-mentioned aging operation can easily make the TD thermal shrinkage at a relatively low temperature, for example, at 65° C., to be 1.0% or less, and the separator thus hardly shrinks in a battery drying step, which is preferable. If the TD thermal shrinkage at 65° C. is 1.0% or less, a possibility that a positive electrode and a negative electrode are faintly contacted can be alleviated, and the self-discharge characteristic is likely to be improved. The TD thermal shrinkage at 65° C. is preferably 0.5% or less, and more preferably 0.2% or less.

Measurements of each parameter described in the present embodiment are carried out according to methods in Examples described later unless otherwise specified.

The separator comprising the polyolefin microporous membrane according to the present embodiment is improved in a balance among the permeability such as the porosity and the average pore diameter, the strength, and the MD/TD tensile elongations as compared with conventional separators while maintaining a high strength, the pore clogging property, and a low thermal shrinkage. Therefore, use of the separator according to the present embodiment especially as a separator for a battery with a high-power density can provide a separator which has excellent high-rate characteristics, and nevertheless has the excellent self-discharge performance and the excellent battery windability (good uniformity).

The separator for the high-power density lithium ion secondary battery according to the present embodiment is suitable particularly for lithium ion secondary batteries for applications requiring high-power density properties, such as electric tools, motorbikes, bicycles, carts, scooters and automobiles, and can impart battery characteristics surpassing conventional ones.

### EXAMPLES

Then, the present embodiment will be described more specifically by way of Examples and Comparative Examples, but the present embodiment is not limited to the following Examples unless departing from the gist. Physical properties in Examples were measured as follows.

### (1) Viscosity-Average Molecular Weight (Mv)

The limiting viscosity [η] in a decalin solvent at 135° C. was determined based on ASTM-D4020. In the case where a membrane was a blended material of a polyethylene and a polypropylene, the viscosity-average molecular weight was calculated by the expression below of polyethylene.

Mv of polyethylene was calculated by the following expression.

[η]=6.77×10⁻⁴ Mv^{0.67}

Mv of polypropylene was calculated by the following expression.

[η]=1.10×10⁻⁴ Mv^{0.08}

### (2) Membrane Thickness (μm)

The membrane thickness was measured using a micro thickness meter, KBM (trade name), made by Toyo Seiki Seisaku-sho, Ltd., at a room temperature of 23±2° C.

### (3) Porosity (%)

A sample of 10 cm×10 cm square was cut out from a microporous membrane; a volume (cm³) and a mass (g) thereof were determined; and the porosity was calculated by the following expression from the volume, the mass and a membrane density (g/cm³).

Porosity=(volume−mass/membrane density)/volume×100

Here, the membrane density was set at a constant of 0.95 for the calculation.

(4) Air Permeability (sec)

The air permeability was measured by a Gurley air permeability tester (G-B2 (trade name), made by Toyo Seiki Seisaku-sho, Ltd.) according to JIS P-8117.

### (5) Puncture Strength (N)

A puncture test was carried out using a handy compression tester, KES-G5 (trade name), made by Kato Tech Co., Ltd., with a sample holder whose opening portion had a diameter of 11.3 mm and a needle tip having a curvature radius of 0.5 mm at a puncture speed of 2 mm/sec in an atmosphere of 23±2° C., to measure a maximum puncture load (N); and the value was defined as the puncture strength.

### (6) Tensile Strength (MPa), and Tensile Elongation (%)

The tensile strength and the tensile elongation of an MD and a TD sample (shape: 10 mm wide×100 mm long) were measured using a tensile tester made by Shimadzu Corp., Autograph AG-A (trade name) according to JIS K7127. A cellophane tape (trade name: N. 29, made by Nitto Denko CS System Corp.) was adhered on each of one surfaces of both ends (each 25 mm) of the sample, and the sample was set on chucks with a distance between the chucks of 50 mm. Further in order to prevent slippage of the sample during the test, a fluororubber having a thickness of 1 mm was adhered on each inside of the chucks of the tensile tester.

The tensile elongation (%) was determined by dividing an elongation amount (mm) until reaching the rupture by the distance (mm) between the chucks, and multiplying the quotient by 100.

The tensile strength (MPa) was determined by dividing a strength at rupture by a sectional area of a sample before the test. The sum total (%) of the MD tensile elongation and the TD tensile elongation was determined by totalizing values of an MD tensile elongation and a TD tensile elongation. The measurement was carried out at a temperature of 23±2° C. at a chuck-pressure of 0.30 MPa and at a tensile rate of 200 mm/min (for a sample for which the between-chuck distance of 50 mm could not be secured, at a strain rate of 400%/min).

### (7) Average Pore Diameter (μm)

A fluid inside a capillary is know to be governed by the Knudsen flow when the mean free path of the fluid is larger than the pore diameter of the capillary, and by the Poiseuile flow when the mean free path of the fluid is smaller than the pore diameter of the capillary. Then, it was assumed that the flow of air in the air permeability measurement of a microporous membrane was governed by the Knudsen flow, and the flow of water in the water permeability measurement of a microporous membrane was governed by the Poiseuile flow.

In this case, the average pore diameter d (μm) can be determined using the following expression from an air permeability rate constant R_{gas} (m³/(m²·sec·Pa)), a water permeability rate constant R_{liq} (m³/(m²·sec·Pa)), an air molecular speed ν (m/sec), a water viscosity η (Pa·sec), a standard pressure Pₛ (=101,325 Pa), a porosity ε (%) and a membrane thickness (μm).

d=2ν×(R_{liq}/R_{gas})×(16η/3Pₛ)×10⁶

Here, R_{gas} was determined using the following expression from the air permeability (sec).

R_{gas}=0.0001/(air permeability×(6.424×10⁻⁴)×(0.01276×101,325))

R_{liq} was determined using the following expression from a water permeability (cm³/(cm²·sec·Pa)).

R_{liq}=water permeability/100

The water permeability was determined as follows. A microporous membrane which had been impregnated with an alcohol was set in a stainless liquid permeation cell of 41 mm in diameter; the membrane was cleaned of the alcohol with water; thereafter, water was made to permeate therethrough by a differential pressure of about 50,000 Pa; and an amount of permeating water per unit time·unit pressure·unit area was calculated from an amount (cm³) of permeating water during an elapse of 120 sec, and was defined as the water permeability.

ν is determined using the following expression from the gas constant R (=8.314), an absolute temperature T (K), the circular constant π, and the average molecular weight of the air M (=2.896×10⁻² kg/mol).

ν=((8R×T)/(π×M))^{1/2}

### (8) Maximum Pore Diameter (μm)

The maximum pore diameter was measured in an ethanol solvent according to ASTM F316-86.

### (9) Thermal Shrinkage at 65° C.

A microporous membrane was cut out in 150 mm in the MD direction and 200 mm in the TD direction, and allowed to stand in an oven at 65° C. for 5 hours. At this time, the microporous membrane was sandwiched between two sheets of paper so as not to be exposed directly to hot air. The microporous membrane was taken out the oven and cooled, and measured for lengths (mm) thereof; and thermal shrinkages of MD and TD were calculated by the following expression. (A sample whose lengths had not been secured was made a sample as long as possible in the range of 150 mm×200 mm.)

MD thermal shrinkage (%)=(150−MD length after heating)/150×100

TD thermal shrinkage (%)=(200−TD length after heating)/200×100

### (10) Warping (mm)

A microporous membrane slit into 60 mm in width and 1,000 mm in length was wound on a plastic core of 8 inches in outer diameter. The reel was unreeled by 1 m on a planar plate, and a portion of 50 cm in the longitudinal direction from the unreeled end was measured for a warping amount (a shift amount (mm) in the TD direction of the microporous membrane strip with respect to the center line in the MD direction thereof). The warping amount is an index of the uniformity of the microporous membrane.

### (11) High-Rate Characteristic (%), and Self-Discharge Characteristic (%)

a. Fabrication of a Positive Electrode

92.2% by mass of a lithium cobalt complex oxide LiCoO₂ as a positive electrode active substance, 2.3% by mass of a scaly graphite and 2.3% by mass of acetylene black as conductive materials, 3.2% by mass of a polyvinylidene fluoride (PVDF) as a binder were dispersed in N-methylpyrrolidone (NMP) to prepare a slurry. The slurry was coated, by a die coater, on one surface of an aluminum foil of 20 μm in thickness to become a positive electrode current collector, dried at 130° C. for 3 min, and thereafter compression-formed by a roll press machine. At this time, the coating amount of the positive electrode active substance was made 250 g/m², and the bulk density of the active substance was made 3.00 g/cm³.

b. Fabrication of a Negative Electrode

96.9% by mass of an artificial graphite as a negative electrode active substance, 1.4% by mass of an ammonium salt of carboxymetyl cellulose and 1.7% by mass of a styrene-butadiene copolymer latex as binders were dispersed in purified water to prepare a slurry. The slurry was coated, by a die coater, on one surface of a copper foil of 12 μm in thickness to become a negative electrode current collector, dried at 120° C. for 3 min, and thereafter compression-formed by a roll press machine. At this time, the coating amount of the negative electrode active substance was made 106 g/m², and the bulk density of the negative active substance was made 1.35 g/cm³.

c. Preparation of a Nonaqueous Electrolyte Solution

LiPF₆ as a solute was dissolved in a concentration of 1.0 mol/L in a mixed solvent of ethylene carbonate and ethyl methyl carbonate of 1:2 (in volume ratio) to prepare a nonaqueous electrolyte solution.

d. Assemblage of a Battery

The separator was cut out in a circle of 18 mmφ, and the positive electrode and the negative electrode were cut out in a circle of 16 mmφ; the positive electrode, the separator and the negative electrode were stacked in this order so that the active substance surfaces of the positive electrode and the negative electrode faced each other; and the stack was housed in a stainless metal container with a lid. The container and the lid were insulated from each other; and the container contacted with the copper foil of the negative electrode, and the lid contacted with the aluminum foil of the positive electrode. The nonaqueous electrolyte solution described above was poured in the container, which was then sealed. The fabricated battery was allowed to stand at room temperature for 1 day, and thereafter is subjected to charging first after fabrication of the battery for a total of 6 hours by a method in which charging was carried out in an atmosphere of 25° C. at a current value of 3 mA (0.5 C) to a battery voltage of 4.2 V, and after the battery voltage reached 4.2 V, the current value started to be decreased from 3 mA so that the battery voltage was held at 4.2 V. Then, the battery was discharged at a current value of 3 mA (0.5 C) to a battery voltage of 3.0 V.

e. Self-Discharge Characteristic/High-Rate Characteristic

The battery was charged for a total of 3 hours by a method in which charging was carried out in an atmosphere of 25° C. at a current value of 6 mA (1.0 C) to a battery voltage of 4.2 V, and after the battery voltage reached 4.2 V, the current value started to be decreased from 6 mA so that the battery voltage was held at 4.2 V. Then, the battery was discharged at a current value of 6 mA (1.0 C) to a battery voltage of 3.0 V. The battery capacity at this time was denoted as X mAh; and the battery was further charged at a current value of 6 mA (1.0 C) to a battery voltage of 4.2 V, and was allowed to stand for 24 hours. This operation was carried out for the total of 50 cells of the battery. Thereafter, the proportion (%) of the cells which maintained a capacity of 90% or more of X out of the 50 cells was calculated as the self-discharge characteristic.

Then, in an atmosphere of 25° C., the batteries which could maintain a capacity of 90% or more described above were each discharged at a current value of 60 mA (10 C) to a battery voltage of 3.0 V. The capacity at this time was denoted as Y mAh; and Y/X×100 (%) was calculated as the high-rate characteristic.

f. Measurement of a Power Density

The positive electrode and the negative electrode fabricated in a and b were stacked in the order of the negative electrode, the separator, the positive electrode and the separator, and wound spirally in plural times to fabricate a cylindrical laminate. The cylindrical laminate was housed in a stainless metal container; a nickel lead led out from the negative electrode current collector was connected to the bottom of the container; and an aluminum lead led out from the positive electrode current collector was connected to a terminal part of the container lid. Then, the nonaqueous electrolyte solution described before was poured in the container, which was then sealed, to fabricate a cylindrical battery of 18 mm in width and 65 mm in height. Thereafter, the battery was charged at a current value of 1 C to a battery voltage of 4.2 V, and after the voltage reached the 4.2 V, the battery was charged for a total of 3 hours by a method in which the current value was gradually decreased with the voltage held at 4.2 V, to make SOC 100%. After 10 min of a suspension, the battery was discharged at a current value of 0.3 C to 50% of SOC, and the discharge was suspended for 1 hour. Thereafter, operations were carried out which were: (1) discharge at 0.5 C for 10 sec, suspension for 1 min, charge at 0.5 C for 10 sec, and suspension for 1 min; (2) discharge at 1 C for 10 sec, suspension for 1 min, charge at 1 C for 10 sec, and suspension for 1 min; (3) discharge at 2 C for 10 sec, suspension for 1 min, charge at 2 C for 10 sec, and suspension for 1 min; (4) discharge at 3 C for 10 sec, suspension for 1 min, charge at 3 C for 10 sec, and suspension for 1 min; and (5) discharge at 5 C for 10 sec, suspension for 1 min, charge at 5 C for 10 sec, and suspension for 1 min.

Respective battery voltages after 10-sec discharge in (1) to (5) were measured, and respective voltages were plotted vs. respective current values. A current value on which an approximate straight line by the method of least squares crossed the discharge lower limit voltage (V) was denoted as (I), and the power density was calculated by the following expression from the current value (I) and a battery mass (Wt).

Power density (P)=(V×I)/Wt

The voltages (4.2 V and 3.0 V) in d, e and f were an example in the case of using a lithium cobalt complex oxide as a positive electrode and a graphite as a negative electrode, and the voltages in measurements were adjusted to the operational voltage range for an electrode material. For example, in the case of using an iron lithium phosphate as a positive electrode and a graphite as a negative electrode, the battery was charged to 3.6 V, and discharged to 2.0 V, and the discharge lower limit voltage was set 2.0 V.

In order to calculate the input density, respective battery voltages after 10-sec charge in (1) to (5) were measured, and respective voltages were plotted vs. respective current values. A current value on which an approximate straight line by the method of least squares crossed the charge upper limit voltage (V) was denoted as (I), and the input density was similarly calculated from the current value (I) and a battery mass (Wt).

### (12) Evaluation of Adaptability to a High-Power Density LIB

The adaptability to an LIB (lithium ion secondary battery) was evaluated according to the following standard.

(A) A high-rate characteristic of 86% or less was set as 4; that of 87 to 90%, as 6; that of 91 to 95%, as 8; and that of 96 to 100%, as 10, (B) a self-discharge characteristic of 90% or less was set as 4; that of 91 to 94%, as 6; that of 95 to 99%, as 8; and that of 100%, as 10, and (C) a warping of 5 mm or more was set as 8; that of 1 to 4 mm, as 9; and that of less than 1 mm, as 10. Then, a sum total of each item of (A), (B) and (C) indicating 28 or more is evaluated as “a”; that of 26 to 27, as “b”; that of 23 to 25, as “c”; that of 21 to 22, as “d”; and that of 20 or less, as “e”. The adaptability was judged to be higher in order from “a”.

### Example 1

47% by mass of a polyethylene homopolymer of 700,000 in Mv, 46% by mass of a polyethylene homopolymer of 300,000 in Mv, and 7% by mass of a polypropylene of 400,000 in Mv (PP blending amount: 7% by mass) were dry blended using a tumbler blender. 1% by mass of pentaerythrityl-tetrakis-[3-(3,5-di-t-butyl-4-hydroxyphenyl]propionate] as an antioxidant was added to 99% by mass of the obtained pure polymer mixture, and the mixture was again dry blended using a tumbler blender to obtain a mixture of the polymers and the another material. After the atmosphere was replaced by nitrogen, the obtained mixture of the polymers and the another material was fed to a twin-screw extruder by a feeder under a nitrogen atmosphere. A fluid paraffin (having a kinematic viscosity at 37.78° C. of 7.59×10⁻⁵ m²/s) was injected to the cylinder of the extruder by a plunger pump.

The feeder and the pump were adjusted so that the ratio of the fluid paraffin accounted for in the whole extruded mixture became 65% by mass (that is, so that the polymer concentration (abbreviated to “PC” in some cases) became 35% by mass). The melting and kneading conditions were: a set temperature of 200° C., a rotation number of the screw of 240 rpm, and a discharge amount of 12 kg/h.

Then, the melted and kneaded material was extruded and cast through a T-die on a cooling roll whose surface temperature was controlled at 25° C. to obtain a gel sheet having a membrane thickness as an original sheet of 1,400 μm.

Then, the gel sheet was introduced to a simultaneous biaxial tenter stretching machine to carry out biaxial stretching. Set stretching conditions were: an MD ratio of 7.0 times, a TD ratio of 7.0 times (that is, 7×7 times), and a biaxial stretching temperature of 125° C.

Then, the stretched sheet was introduced to a methyl ethyl ketone tank, fully immersed in methyl ethyl ketone to extract and remove the fluid paraffin, and thereafter methyl ethyl ketone was dried and removed.

Then, in order to carry out the heat setting (abbreviated to “HS” in some cases), the resultant sheet was introduced to a TD tenter, and thermally set at a heat setting temperature of 125° C. and at a stretch ratio of 1.4 times, and thereafter subjected to a relaxation operation of 0.8 times (that is, an HS relaxation rate of 0.8 times).

Thereafter, a master roll (MR) obtained by taking up 1,000 m of the sheet was left in a temperature-controlled chamber at 60° C. for 24 hours (that is, the case having received MR aging). Thereafter, the master roll was rewound at a winding tensile force of 10 kg/m to obtain a polyolefin microporous membrane for a high-power density lithium ion secondary battery. The obtained microporous membrane was evaluated for various characteristics. The results are shown in Table 1 below.

### Examples 2 to 18, and Comparative Examples 1 to 6

Microporous membranes were obtained as in Example 1, except for conditions indicated in Tables 1 and 2 below. The obtained microporous membranes were evaluated for various characteristics. The results are shown in Tables 1 and 2 below.

TABLE 1

| | | Example | | | | | | |
|---|---|---|---|---|---|---|---|---|
| | | 1 | 2 | 3 | 4 | 5 | 6 | 7 |
| PC (mass %) | | 35 | | | | 30 | 38 | 35 |
| Mv-700,000 PE | | 47/46 | | | | | | |
| (mass %)/Mv-300,000 PE (mass %) | | | | | | | | |
| PP blend (mass %) | | 7 | | | | | | |
| Original membrane thickness (μm) | | 1400 | 1800 | 2000 | 2200 | 2300 | 1700 | 2000 |
| Biaxial stretch ratio (times) | | 7 × 7 | | | | | | |
| Biaxial stretching temperature (° C.) | | 125 | | | | 123 | 127 | 128 |
| HS relaxation rate (times) | | 0.8 | | | | | | |
| HS temperature (° C.) | | 125 | | | 127 | 125 | | |
| HS stretch ratio (times) | | 1.4 | | | | | | |
| MR aging | | present (at 60° C. for 24 hours) | | | | | | |
| Membrane thickness (μm) | | 18 | 22 | 25 | 25 | 25 | 25 | 25 |
| Porosity (%) | | 45 | 45 | 45 | 40 | 45 | 45 | 45 |
| Average pore diameter (μm) | | 0.07 | 0.07 | 0.07 | 0.07 | 0.09 | 0.06 | 0.07 |
| Maximum pore diameter (μm) | | 0.09> | 0.09> | 0.09> | 0.09> | 0.09> | 0.09> | 0.09> |
| Air permeability (sec) | | 220 | 270 | 300 | 380 | 230 | 390 | 270 |
| Puncture strength (N) | | 4.3 | 5.3 | 6.0 | 6.2 | 5.8 | 6.2 | 3.0 |
| Tensile strength (MPa) | MD | 120 | 120 | 120 | 140 | 110 | 120 | 60 |
| | TD | 100 | 100 | 100 | 110 | 90 | 100 | 60 |
| Tensile elongation (%) | MD | 50 | 50 | 50 | 50 | 50 | 50 | 60 |
| | TD | 90 | 90 | 90 | 100 | 90 | 90 | 120 |
| The sum of MD and TD tensile | | 140 | 140 | 140 | 150 | 140 | 140 | 180 |
| elongations (%) | | | | | | | | |
| Thermal shrinkage at 65° C. (%) | | 0.4 | 0.4 | 0.4 | 0.2 | 0.6 | 0.4 | 0.2 |
| High-rate characteristic (%) | | 96 | 94 | 92 | 90 | 94 | 90 | 90 |
| Self-discharge characteristic (%) | | 90 | 94 | 100 | 100 | 94 | 100 | 98 |
| Warping (mm) | | 1> | 1> | 1> | 1> | 1> | 1> | 1 |
| Adaptability evaluation to | | c | c | a | b | c | b | c |
| high-power LIB | | | | | | | | |
| Power density/input density (W/kg) | | 1350/1000 | 1250/940 | 1200/900 | 1150/880 | 1240/980 | 1090/820 | 1210/900 |
| | | Example | | | | | | |
| | | 8 | 9 | 10 | 11 | 12 | 13 | 14 |
| PC (mass %) | | 35 | | | 25 | 40 | 30 | 35 |
| Mv-700,000 PE | | 47/46 | 50/48 | 43/42 | 47/46 | | | 0/93 |
| (mass %)/Mv-300,000 PE (mass %) | | | | | | | | |
| PP blend (mass %) | | 7 | 2 | 15 | 7 | | | |
| Original membrane thickness (μm) | | 2000 | 1000 | 2900 | 2800 | 1800 | 2600 | 2000 |
| Biaxial stretch ratio (times) | | 7 × 7 | 6 × 6 | 8 × 8 | 7 × 7 | | | |
| Biaxial stretching temperature (° C.) | | 125 | | | 122 | 126 | 123 | 125 |
| HS relaxation rate (times) | | 0.8 | | | | | | |
| HS temperature (° C.) | | 125 | | | 125 | 126 | 128 | 123 |
| HS stretch ratio (times) | | 1.4 | 1.0 | 1.6 | 1.4 | | | |
| MR aging | | absent | present (at 60° C. for | | present (at 60° C. for 24 hours) | | | |
| | | | 24 hours) | | | | | |
| Membrane thickness (μm) | | 25 | 25 | 25 | 25 | 25 | 25 | 25 |
| Porosity (%) | | 45 | 43 | 46 | 45 | 42 | 38 | 45 |
| Average pore diameter (μm) | | 0.07 | 0.08 | 0.06 | 0.11 | 0.04 | 0.09 | 0.07 |
| Maximum pore diameter (μm) | | 0.09> | 0.09> | 0.09> | 0.10 | 0.09> | 0.09> | 0.09> |
| Air permeability (sec) | | 300 | 320 | 200 | 200 | 420 | 390 | 300 |
| Puncture strength (N) | | 6.0 | 6.0 | 3.5 | 5.6 | 6.1 | 6.3 | 6.0 |
| Tensile strength (MPa) | MD | 120 | 130 | 70 | 110 | 120 | 120 | 120 |
| | TD | 100 | 90 | 80 | 90 | 100 | 100 | 100 |
| Tensile elongation (%) | MD | 50 | 90 | 15 | 40 | 70 | 60 | 80 |
| | TD | 90 | 150 | 25 | 80 | 100 | 90 | 120 |

| | | | | | | | |
|---|---|---|---|---|---|---|---|
| The sum of MD and TD tensile | 140 | 240 | 40 | 120 | 170 | 150 | 200 |
| elongations (%) | | | | | | | |
| Thermal shrinkage at 65° C. (%) | 1.2 | 0.4 | 0.8 | 0.9 | 0.4 | 0.2 | 0.9 |
| High-rate characteristic (%) | 92 | 90 | 90 | 94 | 86 | 86 | 92 |
| Self-discharge characteristic (%) | 90 | 100 | 94 | 88 | 100 | 100 | 94 |
| Warping (mm) | 1> | 1 | 1 | 1> | 1> | 1> | 5 |
| Adaptability evaluation to | d | c | d | d | c | c | d |
| high-power LIB | | | | | | | |
| Power density/input density (W/kg) | 1190/880 | 1010/810 | 1210/910 | 1260/920 | 1010/800 | 1020/830 | 1180/910 |

TABLE 2

| | | Example | | | | Comparative Example | | | | | |
|---|---|---|---|---|---|---|---|---|---|---|---|
| | | 15 | 16 | 17 | 18 | 1 | 2 | 3 | 4 | 5 | 6 |
| PC (mass %) | | 35 | | | | 35 | | | | | |
| Mv-700,000 PE | | 43/42 | 49/48 | 43/42 | 49/48 | 50/50 | 47/46 | 50/49 | 43/42 | 50/49 | 43/42 |
| (mass %)/Mv-300,000 | | | | | | | | | | | |
| PE (mass %) | | | | | | | | | | | |
| PP blend (mass %) | | 15 | 3 | 15 | 3 | — | 7 | 1 | 15 | 1 | 15 |
| Original membrane | | 2000 | 1000 | 2000 | 1000 | 1500 | 1400 | 1500 | 2500 | 1500 | 2500 |
| thickness (μm) | | | | | | | | | | | |
| Biaxial stretch ratio | | 7 × 7 | 6 × 6 | 7 × 7 | 6 × 6 | 6 × 6 | 7 × 5 | 6 × 6 | 8 × 8 | 6 × 6 | 8 × 8 |
| (times) | | | | | | | | | | | |
| Biaxial stretching | | 125 | | | | 123 | 125 | 123 | 128 | 123 | 128 |
| temperature (° C.) | | | | | | | | | | | |
| HS relaxation rate | | 0.8 | | | | | | | | | |
| (times) | | | | | | | | | | | |
| HS temperature (° C.) | | 127 | 125 | 124 | 123 | 125 | | | | 124 | |
| HS stretch ratio | | 1.4 | 1.0 | 1.4 | | | | | | | |
| (times) | | | | | | | | | | | |
| MR aging | | present (at 60° C. for | | present (at 60° C. for | | present (at 60° C. for 24 hours) | | | | absent | |
| | | 48 hours) | | 12 hours) | | | | | | | |
| Membrane thickness | | 25 | 25 | 25 | 25 | 25 | 25 | 25 | 25 | 25 | 25 |
| (μm) | | | | | | | | | | | |
| Porosity (%) | | 44 | 44 | 46 | 46 | 45 | 45 | 45 | 46 | 46 | 47 |
| Average pore diameter | | 0.06 | 0.08 | 0.06 | 0.08 | 0.08 | 0.07 | 0.07 | 0.04 | 0.08 | 0.04 |
| (μm) | | | | | | | | | | | |
| Maximum pore | | 0.09> | 0.09> | 0.09> | 0.09> | 0.09> | 0.09> | 0.09> | 0.09> | 0.09> | 0.09> |
| diameter (μm) | | | | | | | | | | | |
| Air permeability (sec) | | 320 | 330 | 300 | 280 | 300 | 300 | 310 | 450 | 280 | 420 |
| Puncture strength (N) | | 3.2 | 6.0 | 3.2 | 6.0 | 6.0 | 2.8 | 6.0 | 3.0 | 6.0 | 3.0 |
| Tensile strength (MPa) | MD | 70 | 130 | 70 | 125 | 120 | 60 | 120 | 60 | 120 | 60 |
| | TD | 70 | 90 | 65 | 90 | 100 | 30 | 100 | 30 | 100 | 35 |
| Tensile elongation (%) | MD | 20 | 85 | 20 | 85 | 90 | 50 | 85 | 20 | 90 | 15 |
| | TD | 35 | 140 | 35 | 140 | 180 | 190 | 175 | 20 | 170 | 25 |

| | | | | | | | | | | |
|---|---|---|---|---|---|---|---|---|---|---|
| The sum of MD and | 55 | 225 | 55 | 225 | 270 | 240 | 260 | 40 | 260 | 40 |
| TD tensile | | | | | | | | | | |
| elongations (%) | | | | | | | | | | |
| Thermal shrinkage | 0 | 0 | 0.8 | 0.8 | 0.4 | 0.1 | 0.4 | 0.4 | 1.1 | 1.1 |
| at 65° C. (%) | | | | | | | | | | |
| High-rate | 92 | 92 | 92 | 92 | 84 | 86 | 86 | 86 | 85 | 86 |
| characteristic (%) | | | | | | | | | | |
| Self-discharge | 98 | 100 | 94 | 94 | 98 | 88 | 99 | 87 | 92 | 88 |
| characteristic (%) | | | | | | | | | | |
| Warping (mm) | 1> | 1 | 1> | 1 | 7 | 4 | 5 | 2 | 6 | 5 |
| Adaptability | b | b | c | c | e | e | e | e | e | e |
| evaluation to | | | | | | | | | | |
| high-power LIB | | | | | | | | | | |
| Power density/input | 1210/890 | 1180/860 | 1190/880 | 1230/910 | 1200/910 | 1190/900 | 1220/910 | 950/780 | 1220/930 | 1020/830 |
| density (W/kg) | | | | | | | | | | |

As is clear from the results of Tables 1 and 2, any of the separators according to the present embodiment (Examples 1 to 18) could achieve a lithium ion secondary battery which was suppressed in the self-discharge and excellent in the high-rate characteristic, and exhibited little warping and excellent uniformity.

The present application is based on Japanese Patent Application No. 2008-123727, filed on May 9, 2008 to Japan Patent Office, the subject of which is incorporated herein by reference.

### INDUSTRIAL APPLICABILITY

The polyolefin microporous membrane according to the present invention is suitably used particularly as a separator for a high-power density lithium ion secondary battery.

1-6. (canceled)

7. A separator for a high-power density lithium ion secondary battery, the separator comprising a polyolefin microporous membrane,
wherein the polyolefin microporous membrane has a tensile strength in a longitudinal direction (MD) of 50 MPa or higher, a tensile strength in a transverse direction (TD) of 50 MPa or higher, and a sum total of an MD tensile elongation and a TD tensile elongation of 20 to 250%; and
the polyolefin microporous membrane comprises a polypropylene.

8. The separator for the high-power density lithium ion secondary battery according to claim 7, wherein the polyolefin microporous membrane has an average pore diameter of less than 0.1 μm.

9. The separator for the high-power density lithium ion secondary battery according to claim 7, wherein the polyolefin microporous membrane has a TD thermal shrinkage at 65° C. of 1.0% or lower.

10. The separator for the high-power density lithium ion secondary battery according to claim 7, wherein the polyolefin microporous membrane has a porosity of 40% or higher.

11. The separator for the high-power density lithium ion secondary battery according to claim 7, wherein the polyolefin microporous membrane has a membrane thickness of 20 μm or more.

12. The separator for the high-power density lithium ion secondary battery according to claim 11, wherein the polyolefin microporous membrane has a TD thermal shrinkage at 65° C. of 1.0% or lower.

13. A high-power density lithium ion secondary battery, comprising the separator for the high-power density lithium ion secondary battery according to any one of claims 7 to 12, a positive electrode, a negative electrode and an electrolyte solution.
